(19) United States
(12) Patent Application Publication
(10) Pub. No.: US 2024/0311590 A1
(43) Pub. Date: Sep. 19, 2024

(54) Method and System for Automatically Disconnecting a Data Link Between a Transmitting Device and an Object, and Computer Program Product

(71) Applicant: Bayerische Motoren Werke Aktiengesellschaft, Muenchen (DE)

(72) Inventors: Marc DEGLER, Muenchen (DE); Florian DOSCH, Seefeld (DE)

(21) Appl. No.: 18/605,939

(22) Filed: Mar. 15, 2024

(30) Foreign Application Priority Data
Mar. 16, 2023 (DE) 10 2023 106 578.5

(51) Int. Cl. G06K 7/10; G01P 15/18

(52) U.S. Cl. CPC G06K 7/10306; G01P 15/18

(57) ABSTRACT

A method for automatically disconnecting a data link between a transmitting device and an object, wherein the transmitting device is connected to the object and is configured to measure translational accelerations and/or rotational accelerations and to generate and emit translational acceleration data and/or rotational acceleration data, wherein the transmitting device is removed from the object, a translational acceleration and/or a rotational acceleration is measured during the removal, and translational acceleration data and/or rotational acceleration data are generated and transmitted by the transmitting device. The transmitted translational acceleration data and/or the transmitted rotational acceleration data are received by an evaluation device that determines whether the transmitting device has been removed from the object by evaluating the received translational acceleration data and/or the received rotational acceleration data, and the data link between the transmitting device and the object is disconnected when the transmitting device has been removed from the object.

### CROSS REFERENCE TO RELATED APPLICATION

This application claims priority under 35 U.S.C. § 119 from German Patent Application No. 10 2023 106 578.5, filed Mar. 16, 2023, the entire disclosure of which is herein expressly incorporated by reference.

### BACKGROUND AND SUMMARY

The present invention relates to a method for automatically disconnecting a data link between a transmitting device and an object, wherein the transmitting device is connected to the object and is configured to generate and emit translational acceleration data and/or rotational acceleration data. Furthermore, the invention relates to a system for automatically disconnecting a data link between a transmitting device and an object, and to a computer program product.

In vehicle construction, transmitting devices such as so-called beacons or tags are used to be able to locate objects provided with said devices, such as vehicles, keys or parts. Unlike beacons, tags act as active transponders that can both receive and transmit radio signals.

To locate an object, such as a vehicle, a beacon or tag is first physically connected to the object. In order to also logically link a real object, such as a vehicle, a key, a package or something else, at the data level or in terms of data, it must be virtually “married”.

EP 3 389 290 B1 discloses a wireless telemetry beacon data fleet management condition determination method that provides access to first data that identify unique beacon identifiers and associate them with objects. It then provides access to second data of threshold and limit values associated with beacon data. It also provides access to a pre-processing telemetry log of telemetry data. Each object located with a vehicle is then determined, wherein the determination of each object located with a vehicle comprises identifying each unique beacon identifier arranged with an initial vehicle position, identifying each unique beacon identifier arranged with a second vehicle position, wherein the second vehicle position is determined by either a speed, a distance, a position or a geofence, wherein the identification of each unique beacon identifier arranged with a second vehicle position determines an exact number of objects arranged with a vehicle.

At the end of the locating process, for example, when the object has reached its end position, the physical connection between the beacon or tag and the object is terminated again, and the beacon or tag and the object must then also be disconnected or “divorced” from each other at the data level or in terms of data. The “divorce” is effected by means of a human intervention by a human being manually removing the beacon or tag from the object and then, or simultaneously, disconnecting the beacon or tag from the object in terms of data, in particular in the database and/or the software.

The present invention is based on the object of providing a method, a system and a computer program product, which make it possible to automatically disconnect a data link between a transmitting device and an object.

To achieve the object, a method, a system, and a computer program product with the features of the independent claims are proposed.

The dependent claims relate to advantageous configurations of the invention.

A first aspect of the invention proposes a method for automatically disconnecting a data link between a transmitting device and an object, wherein the transmitting device is connected to the object and is configured to measure translational accelerations and/or rotational accelerations and to use them to generate and emit translational acceleration data and/or rotational acceleration data. In the method, the transmitting device is removed from the object. In this case, a translational acceleration and/or a rotational acceleration is measured and translational acceleration data and/or rotational acceleration data are generated and transmitted by means of the transmitting device. The transmitted translational acceleration data and/or the transmitted rotational acceleration data are received by an evaluation device and it is determined whether the transmitting device has been removed from the object by evaluating the received translational acceleration data and/or the received rotational acceleration data by way of the evaluation device. The data link between the transmitting device and the object is disconnected if it is determined that the transmitting device has been removed from the object.

The method according to the invention is based on the idea of using the translational acceleration data and/or rotational acceleration data emitted by the transmitting device to determine whether the transmitting device has been removed from the object. If it is detected that the transmitting device has been removed from the object, the data disconnection or “divorce” between the transmitting device and the object is initiated automatically.

The object can be a vehicle, a key, a package, or a part. The transmitting device may be a tag, especially an ultra wideband tag (UWB tag).

Advantageously, the transmitting device measures translational accelerations in the x, y and z directions and/or rotational accelerations around the x, y and z axes during removal from the object.

Advantageously, the transmitting device is disconnected from the object automatically, in particular automatically by means of the evaluation device.

The evaluation device can be a data processing device. The evaluation device may have a storage device having a computer program product and a database, in which object identification data and/or transmitting device identification data can be stored, a computing unit such as a CPU, and a receiver device for receiving the translational acceleration data and/or rotational acceleration data emitted by the transmitting device. The computing unit is advantageously configured to perform steps d.) and e.) of the method according to the invention. The storage device can store a computer program product which is loaded into the computing unit and is used to perform steps d.) and e.) of the method according to the invention. For receiving the translational acceleration data and/or rotational acceleration data, the evaluation device may have a receiver. The evaluation device can also be used to calculate the position of the object by virtue of the evaluation device, in particular a receiver of the evaluation device or the computing unit, using the translational acceleration data and/or rotational acceleration data received from the transmitting device to calculate the position of the object.

In one advantageous configuration, the received translational acceleration data and/or rotational acceleration data are analyzed and evaluated by means of a computer program product or software. For this purpose, the computer program product may have an algorithm which, on the basis of the received translational acceleration data and/or received rotational acceleration data, determines whether the transmitting device has been removed from the object. The algorithm can be trained for this purpose. As soon as the transmitting device has been uncoupled, the computer program product, in particular the algorithm contained therein, can detect this and initiates the data disconnection or “divorce” between the object and the transmitting device. The computer program product, in particular the algorithm contained therein, can detect, on the basis of the received translational acceleration data and/or received rotational acceleration data, whether the transmitting device has been removed from the object, for example by a person, or whether the object, for example a vehicle, is moving. Advantageously, the computer program product, in particular the algorithm contained therein, is designed not to identify a movement of the object as removal of the transmitting device from the object. Advantageously, the computer program product is stored in the storage device of the evaluation device and is loaded into the computing unit of the evaluation device in order to carry out the method.

In one advantageous configuration, the evaluation device generates a signal which disconnects the transmitting device and the object from one another in terms of data. The signal generated by the evaluation device is advantageously a process-safe signal that triggers a data disconnection. Therefore, a computer program product stored in the evaluation device, in particular an algorithm included in the computer program product, can automatically determine, based on the received translational acceleration data and/or received rotational acceleration data, whether the transmitting device has been removed from the object, and, if it is determined that the transmitting device has been removed from the object, the computer program product, in particular the algorithm contained therein, can instruct the evaluation device to generate a signal or a command that causes a data disconnection of the transmitting device from the object.

In one advantageous configuration, the transmitting device has at least one acceleration sensor for measuring translational accelerations and generating translational acceleration data and/or at least one angle sensor for measuring rotational accelerations and generating rotational acceleration data. When the transmitting device is being removed from the object, both translational accelerations and rotational accelerations act on the transmitting device. These accelerations can be measured, converted into data and emitted by the sensors contained in the transmitting device.

In one advantageous configuration, the acceleration sensor is designed to measure translational accelerations in three axes and the angle sensor is designed to measure rotational accelerations around three axes. This allows the acceleration sensor to measure accelerations in the x, y, and z directions. For example, the acceleration sensor measures a negative acceleration in the z direction when the transmitting device is being removed, in particular when the transmitting device is being uncoupled. The computer program product, in particular the algorithm contained therein, can identify the negative acceleration measured in the z direction as removal of the transmitting device, in particular as uncoupling of the transmitting device, from the vehicle. The angle sensor can measure rotational accelerations around the x, y, and z axes.

In one advantageous configuration, the transmitting device is connected in a fixed position to a section of the object. Further advantageously, the transmitting device is suspended in a fixed position from a section of the object, wherein, for removing the transmitting device from the section of the object, the transmitting device is uncoupled. Advantageously, the transmitting device is attached to or suspended from a mirror of the vehicle in a fixed position. To remove the transmitting device from the object, the transmitting device can be uncoupled from the mirror. Further advantageously, the transmitting device has a hanger which is used to suspend the transmitting device from a mirror of the vehicle.

In one advantageous configuration, transmitting device identification data relating to the transmitting device and object identification data relating to the object are linked to one another in a database in terms of data. The evaluation device may comprise the database which may be stored in a storage device of the evaluation device. The transmitting device identification data and/or the object identification data are advantageously data for identifying the transmitting device and/or the object, such as a number. For storing the object identification data and/or the transmitting device identification data, the object and/or the transmitting device may be provided with a QR code in which the corresponding identification data are stored. By scanning the QR code, the object identification data and/or transmitting device identification data are transmitted to the evaluation device, linked or “married” in terms of data and stored in the storage device.

In one advantageous configuration, the transmitting device is in the form of a tag. A tag is a radio transmitter that can emit radio signals as well as receive and process radio signals for positioning. The tag can be an ultra wideband tag (UWB tag).

A further aspect of the invention proposes a system for automatically disconnecting a data link between a transmitting device and an object using the method according to the invention. The system has at least one transmitting device which can be connected to the object and is configured to measure translational accelerations and/or rotational accelerations and to use them to generate and emit translational acceleration data and/or rotational acceleration data, and an evaluation device which is configured to determine, by evaluating the received translational acceleration data and/or the received rotational acceleration data, whether the transmitting device has been removed from the object, and to disconnect the data link between the transmitting device and the object if it has been determined that the transmitting device has been removed from the object.

The evaluation device may be in the form of a data processing device. The evaluation device may have a storage device having a computer program product and a database, in which object identification data and/or transmitting device identification data can be stored, a computing unit such as a CPU, and a receiver device for receiving the translational acceleration data and/or rotational acceleration data emitted by the transmitting device. The computing unit is advantageously configured to perform steps d.) and e.) of the method according to the invention. The storage device can store a computer program product which is loaded into the computing unit and is used to perform steps d.) and e.) of the method according to the invention. The evaluation device can also be used to calculate the position of the object by virtue of the evaluation device, in particular a receiver of the evaluation device or the computing unit, using the translational acceleration data and/or rotational acceleration data received from the transmitting device to calculate the position of the object.

A further aspect of the invention proposes a computer program product comprising instructions which cause the system according to the invention to carry out the method according to the invention.

A method and a system for automatically disconnecting a data link between a transmitting device and an object, a vehicle and further features and advantages are described in more detail below using an exemplary embodiment which is schematically illustrated in the figures, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a vehicle with a suspended transmitting device which are linked to one another in terms of data;

FIG. 2 shows a schematic illustration of removal of the transmitting device from the vehicle and an evaluation device which receives and evaluates the acceleration data and/or angle data emitted by the transmitting device; and

FIG. 3 shows a schematic illustration of a method for automatically disconnecting the data link between the transmitting device and the vehicle.

### DETAILED DESCRIPTION OF THE DRAWINGS

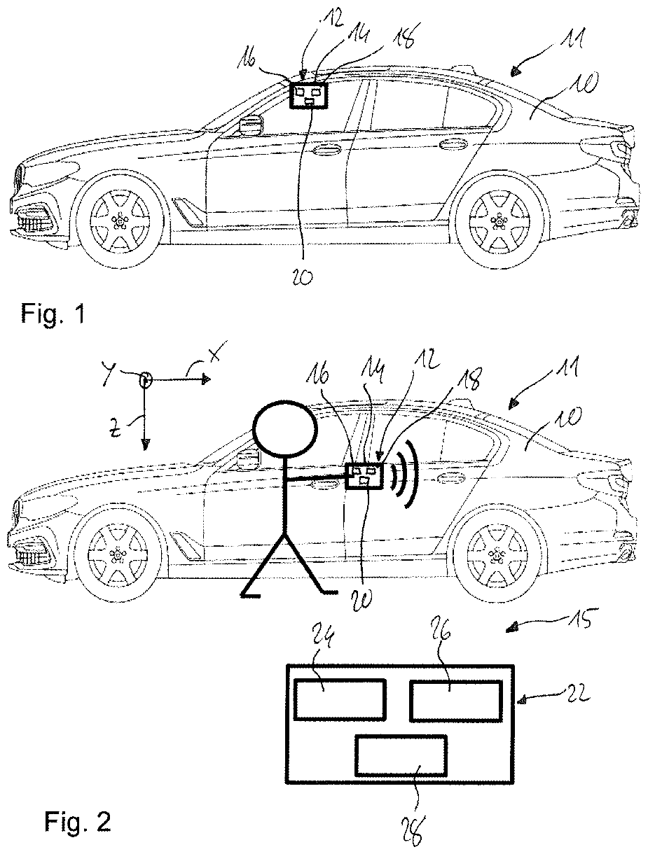

FIG. 1 shows an object 11 which is in the form of a vehicle 10 in the present case. The vehicle 10 has a drive machine in the form of an internal combustion engine and/or an electric motor.

For locating the vehicle 10, a transmitting device 12 is connected to the vehicle 10. The transmitting device 12 is, for example, a tag, in particular an ultra wideband tag (UWB tag), and can emit data-containing signals.

The transmitting device 12 is connected in a fixed position to the vehicle 10. For this purpose, the transmitting device 12 may have a hanger which is not illustrated and is used to suspend the transmitting device 12 from a mirror of the vehicle 10.

For positioning of the vehicle 10, the transmitting device 12 transmits signals which are received by a receiver that is not illustrated. The receiver or a data processing device that is not illustrated uses these signals to calculate the position of the vehicle 10.

For positioning of the vehicle 10, it is necessary to link or “marry” the transmitting device 12 and the vehicle 10 to one another in terms of data. For this purpose, object identification data relating to the object 11 that are stored in a database and stored transmitting device identification data relating to the transmitting device 12 are linked to one another in terms of data.

When the vehicle 10 has reached its end position, the transmitting device 12 is manually removed from the vehicle 10 by uncoupling the transmitting device 12 from the mirror, as illustrated schematically in FIG. 2. In addition to the manual removal of the transmitting device 12 from the vehicle 10, it is also necessary for the transmitting device 12 to also be disconnected or “divorced” from the vehicle 10 in terms of data.

The system 15 schematically illustrated in FIG. 2 is used to automatically disconnect the transmitting device 12 from the vehicle 10 in terms of data. The system 15 has the transmitting device 12 and an evaluation device 22.

The transmitting device 12 of the system 15 has an acceleration sensor 16 for measuring translational accelerations in the x, y and z directions, an angle sensor 18 for measuring rotational accelerations around the x, y and z axes, and a transmitter 20 which transmits the measured translational accelerations as translational acceleration data and the measured rotational accelerations as rotational acceleration data.

The evaluation device 22 has a receiver 24 for receiving the transmitted translational acceleration data and the rotational acceleration data, a computing unit 26, for example a CPU, and a storage device 28 for storing a computer program product. The database, in which the stored object identification data relating to the object 11 and stored transmitting device identification data relating to the transmitting device 12 are linked to one another in terms of data, can be stored in the storage device 28. Alternatively, the database, in which the stored object identification data relating to the object 11 and stored transmitting device identification data relating to the transmitting device 12 are linked to one another in terms of data, can be stored in a storage device of a data processing device not illustrated.

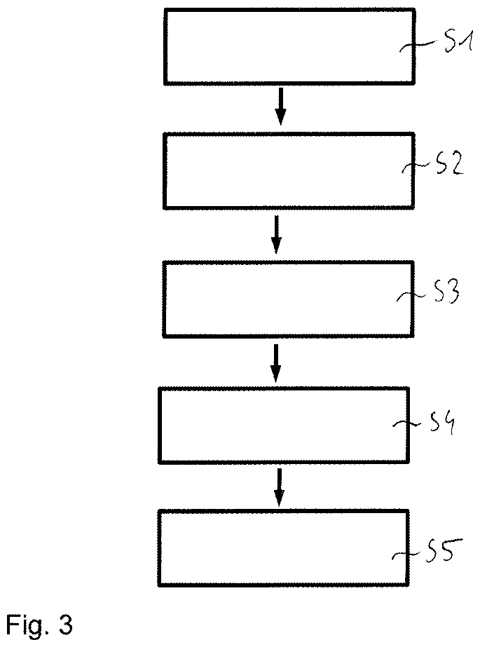

In order to automatically disconnect the data link between the transmitting device 12 and the vehicle 10, the method schematically illustrated in FIG. 3 is carried out.

In a first step S1, the transmitting device 12 is removed, in particular uncoupled, from the vehicle 10.

In a second step S2, the acceleration sensor 16 measures the translational accelerations occurring during uncoupling in the x, y and z directions and the angle sensor 18 measures the rotational accelerations occurring during uncoupling of the transmitting device 12 about the x, y and z axes. The measured translational and rotational accelerations are converted into translational acceleration data and rotational acceleration data and are transmitted by means of the transmitter 20.

In a third step S3, the transmitted translational acceleration data and rotational acceleration data are received by the receiver 24.

In a fourth step S4, the received translational acceleration data and rotational acceleration data are evaluated in the evaluation device 22 and are taken as a basis for determining whether the transmitting device 12 has been removed from the vehicle 10. For this purpose, a computer program product which is stored in the storage device 28 and has an algorithm for evaluating the translational acceleration data and the rotational acceleration data, is loaded into the computing unit 26. In the computing unit 26, the computer program product, in particular its algorithm, is executed, and the received translational acceleration data and rotational acceleration data are evaluated. The algorithm can draw conclusions on the location and position of the transmitting device 12 on the basis of the translational acceleration data and rotational acceleration data and detects, for example when the acceleration sensor 16 measures a negative acceleration in the z direction, that the transmitting device 12 has been removed, in particular uncoupled, from the vehicle 10.

If the computer program product, in particular the algorithm contained therein, detects in step S4 that the transmitting device 12 has been uncoupled from the vehicle 10, then the evaluation device 22, in particular the computing unit 26, generates, in a fifth step S5, a signal which triggers data unlinking or “divorce” of the transmitting device 12 from the vehicle 10. As a result, the transmitting device 12 and the vehicle 10 are no longer linked to one another in the database in terms of data.

The system 15, the method and the computer program product make it possible to automatically disconnect the transmitting device 12, which is linked to the vehicle 10 in terms of data, based on the data from the transmitting device 12.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

List of reference signs

| | |
|---|---|
| 10 | Vehicle |
| 11 | Object |
| 12 | Transmitting device |
| 14 | Tag |
| 15 | System |
| 16 | Acceleration sensor |
| 18 | Angle sensor |
| 20 | Transmitter |
| 22 | Evaluation device |
| 24 | Receiver |
| 26 | Computing unit |
| 28 | Storage device |
| S1 | First step |
| S2 | Second step |
| S3 | Third step |
| S4 | Fourth step |
| S5 | Fifth step |
| x | x direction |
| y | y direction |
| z | z direction |

What is claimed is:

1. A method for automatically disconnecting a data link between a transmitting device and an object, wherein the transmitting device is connected to the object and is configured to measure translational accelerations and/or rotational accelerations and to generate and emit translational acceleration data and/or rotational acceleration data based on the translational accelerations and/or the rotational accelerations, the method comprising:
a. removing the transmitting device from the object;
b. measuring a translational acceleration and/or a rotational acceleration during removal of the transmitting device and generating and transmitting the translational acceleration data and/or the rotational acceleration data via the transmitting device;
c. receiving the transmitted translational acceleration data and/or the transmitted rotational acceleration data by way of an evaluation device;
d. determining whether the transmitting device has been removed from the object by evaluating the received translational acceleration data and/or the received rotational acceleration data by the evaluation device; and
e. automatically disconnecting the data link between the transmitting device and the object in response to determining in step d) that the transmitting device has been removed from the object.

2. The method according to claim 1, wherein the evaluation device generates a signal which disconnects the transmitting device and the object from one another in terms of data.

3. The method according to claim 1, wherein the transmitting device has at least one acceleration sensor for measuring the translational accelerations and generating the translational acceleration data and/or at least one angle sensor for measuring the rotational accelerations and generating the rotational acceleration data.

4. The method according to claim 2, wherein the transmitting device has at least one acceleration sensor for measuring the translational accelerations and generating the translational acceleration data and/or at least one angle sensor for measuring the rotational accelerations and generating the rotational acceleration data.

5. The method according to claim 3, wherein the acceleration sensor is designed to measure translational accelerations in three axes, and wherein the angle sensor is designed to measure rotational accelerations around three axes.

6. The method according to claim 4, wherein the acceleration sensor is designed to measure translational accelerations in three axes, and wherein the angle sensor is designed to measure rotational accelerations around three axes.

7. The method according to claim 1, wherein the transmitting device is connected in a fixed position to a section of the object.

8. The method according to claim 2, wherein the transmitting device is connected in a fixed position to a section of the object.

9. The method according to claim 3, wherein the transmitting device is connected in a fixed position to a section of the object.

10. The method according to claim 4, wherein the transmitting device is connected in a fixed position to a section of the object.

11. The method according to claim 1, wherein transmitting device identification data relating to the transmitting device and object identification data relating to the object are linked to one another in a database in terms of data.

12. The method according to claim 2, wherein transmitting device identification data relating to the transmitting device and object identification data relating to the object are linked to one another in a database in terms of data.

13. The method according to claim 3, wherein transmitting device identification data relating to the transmitting device and object identification data relating to the object are linked to one another in a database in terms of data.

14. The method according to claim 4, wherein transmitting device identification data relating to the transmitting device and object identification data relating to the object are linked to one another in a database in terms of data.

15. The method according to claim 1, wherein the transmitting device is in the form of a tag.

16. The method according to claim 2, wherein the transmitting device is in the form of a tag.

17. The method according to claim 3, wherein the transmitting device is in the form of a tag.

18. The method according to claim 4, wherein the transmitting device is in the form of a tag.

19. A system for automatically disconnecting a data link between a transmitting device and an object using a method according to claim 1, the system comprising at least one transmitting device which can be connected to the object and is configured to measure translational accelerations and/or rotational accelerations and to generate and emit translational acceleration data and/or rotational acceleration data based on the translational accelerations and/or the rotational accelerations, and an evaluation device which is configured to determine, by evaluating the received translational acceleration data and/or the received rotational acceleration data, whether the transmitting device has been removed from the object, and to disconnect the data link between the transmitting device and the object if it has been determined that the transmitting device has been removed from the object.

20. A computer program product comprising instructions which cause a system according to claim 19 to carry out a method including:
a. removing the transmitting device from the object;
b. measuring a translational acceleration and/or a rotational acceleration during removal of the transmitting device and generating and transmitting the translational acceleration data and/or the rotational acceleration data via the transmitting device;
c. receiving the transmitted translational acceleration data and/or the transmitted rotational acceleration data by way of an evaluation device;
d. determining whether the transmitting device has been removed from the object by evaluating the received translational acceleration data and/or the received rotational acceleration data by the evaluation device; and
e. automatically disconnecting the data link between the transmitting device and the object in response to determining in step d) that the transmitting device has been removed from the object.
